(19) United States
(12) Patent Application Publication
(10) Pub. No.: US 2017/0360209 A1
(43) Pub. Date: Dec. 21, 2017

(54) FOLDABLE ELECTRIC BED

(71) Applicant: CHANGZHOU YUFENG FURNITURE COMPANY LIMITED, CHANGZHOU (CN)

(72) Inventors: JIE ZHOU, SYDNEY (AU); WU SHEN, CHANGZHOU (CN); CHULAI MAO, CHANGZHOU (CN)

(73) Assignee: CHANGZHOU YUFENG FURNITURE COMPANY LIMITED, CHANGZHOU (CN)

(21) Appl. No.: 15/627,862

(22) Filed: Jun. 20, 2017

(30) Foreign Application Priority Data
Jun. 20, 2016 (CN) 201620598693.3

(51) Int. Cl. A47C 20/04; A61G 7/002; A47C 17/86; A47C 20/00; A47C 19/12

(52) U.S. Cl. CPC A47C 20/041; A61G 7/002; A47C 17/86; A47C 19/12; A47C 20/00

(57) ABSTRACT

A foldable electric bed comprises a front frame, a rear frame and several pieces of bed boards. The front frame is provided with a front base which is fixedly provided with a front supporting part used for supporting the bed boards arranged at the front frame. The rear frame is provided with a rear base which is fixedly provided with a rear supporting part used for supporting the bed boards arranged at the rear frame. The front base and the rear base are articulated at an articulating shaft through a connector and an axle pin, such that the front frame and the rear frame are able to fold between an unfolded position and a folded position in relation to each other. At the unfolded position, the front frame and the rear frame are adjacent to each other along the horizontal direction.

### CROSS REFERENCE TO RELATED PATENT APPLICATION

The present application claims the priority of the CN 201620598693.3 filed on Jun. 20, 2016, which application is incorporated herein by reference.

### FIELD OF THE INVENTION

The utility model relates to an electric bed, in particular a foldable electric bed.

### BACKGROUND OF THE INVENTION

People have increasingly high requirement on sleep quality along with the improvement of living standard. Therefore, more and more people choose smarter electric bed to improve their sleep quality.

Generally, the electric bed has high mechanical integration level and demanding strength, thus most electric beds adopt integration design, which causes a problem that workers have to transport and handle such integrated electric bed with large volume and heavy weight. However, the workers may be unable to convey the electric bed into room successfully under the condition of limited space of residential lift and insufficient width of corridor.

To this end, the prior art proposes to separate the electric bed into front and rear frames which are hinged by means of articulating, and reduce the area occupied by the electric bed by means of folding, so as to be advantageous for transporting and handling. However, the hinge joint of the existing electric bed which is provided with the front and rear frames bears the weight of the whole electric bed and may be damaged easily. In addition, during the transportation, in case of bumpy road, the actuate components of the electric bed may be bumped and damaged because of the insecure hinge joint.

### SUMMARY OF THE INVENTION

It should be noted that the foldable electric bed of the utility model aims at overcoming one or more of disadvantages discovered by the prior art.

To this end, the utility model proposes a new foldable electric bed which can decrease the weight born by the hinge joint and effectively reduce the probability of damage during the process of transporting and handling, and the foldable electric bed is realized by the following technical solutions:

A foldable electric bed comprises a front frame, a rear frame and several pieces of bed boards arranged at the front frame and the rear frame, wherein:

The front frame is provided with a front base which is fixedly provided with a front supporting part used for supporting the bed boards arranged at the front frame,

The rear frame is provided with a rear base is fixedly provided with a rear supporting part used for supporting the bed boards arranged at the rear frame,

Wherein the front base and the rear base are hinged with an articulating shaft through a connector and an axle pin, such that the front frame and the rear frame are able to fold in relation to each other between an unfolded position and a folded position. At the unfolded position, the front frame and the rear frame are adjacent to each other along the horizontal direction. At the folded position, the front base of the front frame turns over to fit the rear base of the rear frame closely in the same horizontal plane around the articulating shaft.

With these arrangements, at the folded position, the front frame and the rear frame support each other, which reduces the force born by the connector and prolongs the service life of the connector. At the same time, compared with the prior art, these arrangements increase the support surface, make the stress more uniform and reduce the probability of damaging the electric bed. In addition, the bed boards according to the utility model are respectively supported on the front supporting part of the front frame and the rear supporting part of the rear frame, instead of being supported on the front frame and the rear frame directly, thus, when the electric bed is folded, the distance between the bed boards of the front frame and the bed boards of the rear frame becomes larger, and there is more space for arranging driving mechanisms for driving the bed boards to turn over.

Furthermore, the connector comprises a flat first mounting part and a second mounting part perpendicular to the first mounting part, the first mounting part is adapted to be mounted at the front frame or the rear frame, and the second mounting part is fit for mounting an axle pin.

The first and second mounting parts of the connector, which are perpendicular to each other, have simple structures and are convenient for using.

Furthermore, the front frame is integrated with a front drive component used for driving at least one of the several pieces of bed boards arranged at the front frame, and wherein the height of the front supporting part protruding from the front base is larger than the height of the front drive component in the front frame, which further ensures that at the folded position, the front drive component arranged in the front frame would not be damaged because of being pushed to the bed boards.

Furthermore, the rear frame is integrated with rear drive component used for driving at least one of the several pieces of bed boards arranged at the rear frame, and wherein the height of the rear supporting part protruding from the rear base is larger than the height of the rear drive component in the rear frame, which further ensures that at the folded position, the rear drive component arranged in the rear frame would not be damaged because of being pushed to the bed boards.

Furthermore, the front base of the front frame comprises a pair of front longitudinal girders extending along the length of said front frame, and a front connecting girder and a front overturning girder which are connected between the pair of front longitudinal girders, and the front overturning girder is used for mounting the connector, wherein the front supporting part is fixed at the pair of front longitudinal girders.

Furthermore, the rear base of the rear frame comprises a pair of rear longitudinal girders extending along the length of said rear frame, and a rear connecting girder and a rear overturning girder which are connected between the pair of rear longitudinal girders, and the rear overturning girder is used for mounting the connector, wherein the rear supporting part is fixed at the pair of rear longitudinal girders.

Furthermore, the front connecting girder of the front frame is provided with front supporting feet with the height equal to that of the front supporting part, such that at the unfolded position, all bed boards of the front frame are located at the same level.

Furthermore, the rear connecting girder of the rear frame is provided with rear supporting feet with the height equal to that of the rear supporting part, such that at the unfolded position, all bed boards of the rear frame are located at the same level.

Furthermore, the rear longitudinal girders of the rear frame are provided with rear longitudinal girder supporting feet with the height equal to that of the rear supporting part, such that at the unfolded position, all bed boards of the rear frame are located at the same level.

Furthermore, the front supporting part at least partially supports two adjacent bed boards arranged at the front frame, and the rear supporting part at least partially supports two adjacent bed boards arranged at the rear frame, so as to increase the reliability of supporting the bed boards.

The foldable electric bed according to the present utility model allows more space between the bed boards of the front frame and the bed boards of the rear frame after folding the front and rear frames so as to be capable of placing the drive components of the electric bed by arranging the front supporting part at the front frame for supporting the bed boards and arranging the rear supporting part at the rear frame for supporting the bed boards. Above all, when being folded, the front and rear frames are aligned and support each other, which reduces the stress of the connector at the hinge joint, reduces the probability of damaging the connector and prolongs the service life of the connector. In addition, the foldable electric bed according to the utility model can be folded and unfolded without additional tool, which provides a convenient mounting manner and is convenient for the installation personnel or the user to mount.

### BRIEF DESCRIPTION OF THE DRAWINGS

It should be understood that all features, variants and/or specific embodiments in the utility model may be combined in many combinations, except the case of apparent contradiction or incompatibility.

Other advantages and features of the utility model will become apparent by reading the following specific embodiments, given by way of non-limiting example, with reference to the accompany drawings, in which:

FIG. 1 is a schematic view showing a foldable electric bed according to an embodiment of the utility model, in an unfolded position, wherein the bed boards of the front rear frames are substantially at the same level;

FIG. 2 is a schematic view showing a foldable electric bed according to an embodiment of the utility model, wherein the bed boards of the front and rear frames are in a working state and are respectively lifted to different heights;

FIG. 3 is a schematic bottom view of the front frame of the foldable electric bed of FIG. 1;

FIG. 4 is a schematic bottom view of the rear frame of the foldable electric bed of FIG. 1;

FIG. 5 is a schematic view of the foldable electric bed of FIG. 1 during the process of folding;

FIG. 6 is a schematic view of the foldable electric bed of FIG. 1 at the folded position;

FIG. 7 is a partial enlarged view of the foldable electric bed of FIG. 6.

### DETAIL DESCRIPTION OF THE INVENTION

It should be understood that the above figures are not in real scale, but are only the diagrams used for explaining various preferred features of the fundamental principles of the utility model. The design features disclosed by the utility model, for example the size, the direction, the orientation and the shape, shall be determined according to specific application and service environment.

Hereinafter, the utility model will be described in detail in combination with the embodiments and the accompanying drawings. In these figures, the same reference numbers designate identical or equivalent elements of the utility model in all figures.

FIG. 1 shows the foldable electric bed 1 of the utility model, wherein the foldable electric bed 1 comprises a front frame 3 and a rear frame 5, wherein the front and rear frames 3 and 5 are connected with each other through a connector 7 and an axle pin 9. When the foldable electric bed 1 is arranged at the unfolded position shown in FIG. 1, the front and rear frames 3 and 5 are substantially located at the same level.

The front frame 3 comprises a front base 31 and a front supporting part 32 fixed at the front base 31, the front supporting part 32 is fixedly provided with a front fixed bed board 12 which is articulated with a front movable bed board 11 which is driven by a front drive component 2 arranged in the front frame 3 and can turn over between a horizontal position and a lifting position.

The rear frame 5 comprises a rear base 51 and a rear supporting part 52 arranged at the rear base 51, the rear supporting part 52 is fixedly provided with a rear fixed bed board 13 which is articulated with a rear movable bed board 14 which is driven by a rear drive component 4 arranged in the rear frame 5 and can turn over between a horizontal position and a lifting position. In addition, the rear movable bed board 14 is also articulated with a rear follow-up bed board 15 which makes driven movement following the movement of the rear movable bed board 14.

It can be seen from FIG. 1 that the front and rear supporting parts 32 and 52 keep a distance between the bed boards and the front and rear bases 31 and 51, and this distance is advantageous for placing the front and rear drive components 2 and 4.

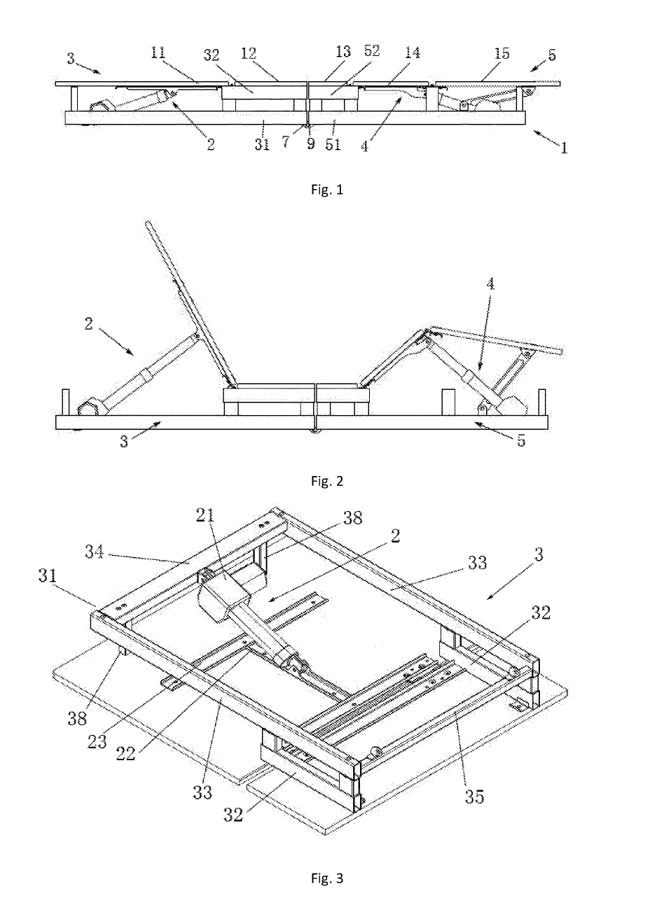

FIG. 2 shows a working state diagram of the foldable electric bed 1, in which the movable bed boards of the front and rear frames 3 and 5 are lifted by the front and rear drive components 2 and 4.

Specifically, referring to FIG. 3, it can be seen that the front base 31 of the front frame 3 comprises a pair of front longitudinal girders 33 extending along the length of said front frame and a front connecting girder 34 and a front overturning girder 35 connected between the pair of front longitudinal girders 33, wherein the pair of front longitudinal girders 33, the front connecting girder 34 and the front overturning girder 35 are successively connected end to end, forming a closed rectangular frame. The front overturning girder 35 is used for mounting the connector 7, and preferably two connectors 7 are symmetrically arranged at the front overturning girder 35, in particular positioned at two sides of the front overturning girder 35 near the pair of front longitudinal girders 33. The front supporting part 32 is fixed at the pair of front longitudinal girders 33 and is close to the front overturning girder 35.

The front drive component 2 comprises a front drive motor 21 and a front support frame 22, wherein one end of the front drive motor 21 is articulated at the middle position of the front connecting girder 34, and the other end is articulated with the front support frame 22. The front support frame 22 is fixed at the front movable bed board 11, and preferably a rivet or axle pin is fixed at the front movable bed board 11. In addition, both ends of the front support frame 22 can be provided with fixing strips 23, so as to improve the firmness.

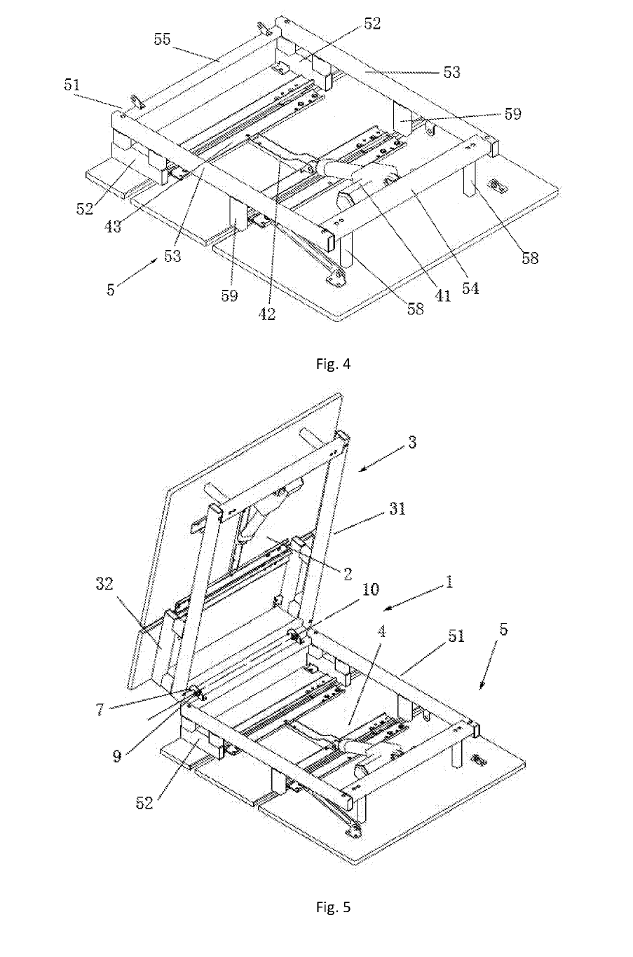

Specifically, referring to FIG. 4, it can be seen that the rear base 51 of the rear frame 5 comprises a pair of rear longitudinal girders 53 extending along the length of said rear frame and a rear connecting girder 54 and a rear overturning girder 55 which are connected between the pair of rear longitudinal girders 53, wherein the pair of rear longitudinal girders 53, the rear connecting girder 54 and the rear overturning girder 55 are successively connected end to end, forming a closed rectangular frame. The rear overturning girder 55 is used for mounting the connector 7 to cooperate with the connector 7 of the front overturning girder 35, and preferably two connectors 7 are symmetrically arranged at the rear overturning girder 55, in particular positioned at two sides of the rear overturning girder 55 near the pair of rear longitudinal girders 53. The rear supporting part 52 is fixed at the pair of rear longitudinal girders 53 and is close to the rear overturning girder 55.

The rear drive component 4 comprises a rear drive motor 41 and a rear support frame 42, wherein one end of the rear drive motor 41 is articulated at the middle position of the rear connecting girder 54, and the other end is articulated with the rear support frame 42. The rear support frame 42 is fixed at the rear movable bed board 14, and preferably a rivet or axle pin is fixed at the rear movable bed board 14. In addition, both ends of the front support frame 22 can be provided with fixing strips 43, so as to improve the firmness.

In particular, the front and rear drive motors 21 and 41 are placed face to face and both make linear movement back and forth by using a push-rod motor, so as to push corresponding movable bed boards to reach corresponding angle to adjust the height of the bed boards.

As shown in FIG. 5, the front and rear frames 3 and 5 are articulated with the articulating shaft 10 through the connectors 7 and axle pins 9 of respective overturning girders and can rotate around the articulating shaft 10 in relation to each other, so as to be folded from the unfolded position to the folded position.

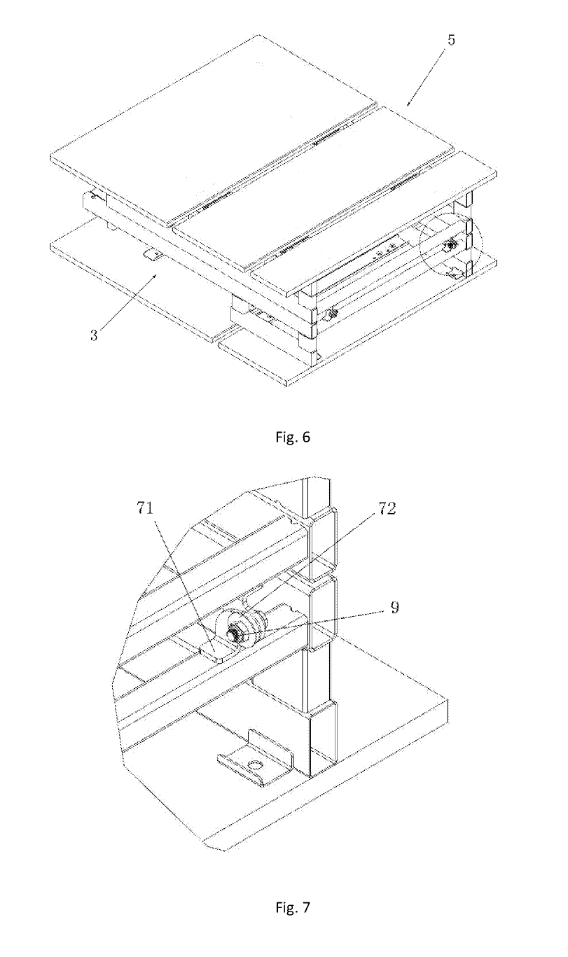

FIG. 6 shows the foldable electric bed at the folded position, wherein the front and rear frames 3 and 5 are overlapping, and the figure shows that the rear frame 5 after being folded is supported above the front frame 3. Certainly, the front frame 3 after being folded can also be supported above the rear frame 5. At the folded position, the bases of the front and rear frames 3 and 5 are close to each other, taking effect of supporting each other.

In addition, it can be seen that the front connecting girder 34 of the front frame 3 is provided with front supporting feet 38 with the height equal to that of the front supporting part 32. Thus, at the folded position, the front supporting feet 38 can prevent the bed boards from collapsing, reduce the stress on the connector 7 and improve the service life of the connector 7.

Likewise, the rear connecting girder 54 of the rear frame 5 is provided with rear supporting feet 58 with the height equal to that of the rear supporting part 52. In addition, the rear longitudinal girders 53 of the rear frame 5 are provided with rear longitudinal girder supporting feet 59 with the height equal to that of the rear supporting part 52, which improves the support to the bed boards of the rear frame 5, reduces the stress on the connector 7 and prolongs the service of the connector 7.

FIG. 7 shows the enlarged view of the hinge joint of the front and rear frames 3 and 5, in which the connector 7 is shown in detail. The connector 7 comprises a flat first mounting part 71 and a second mounting part 72 extending perpendicular to the first mounting part 71. The first mounting part 71 is adapted to be mounted at the front frame 3 or at the rear frame 5, in particular by welding. The second mounting part 72 is provided with a through-hole and is fit for mounting the axle pin 9. Wherein the second mounting part 72 is at least wider than the first mounting part 71, and the portion wider than the first mounting part 71 is used for arranging the through-hole.

As a variant, the connector can also be provided with a supporting block, such as a bar, for supporting the second mounting part, so as to improve the strength of the connector.

In the present utility model, the girders contained by respective bases of the front and rear frames 3 and 5 are preferably rectangular girders, so as to increase the contact area of the front and rear frames 3 and 5 at the folded position and improve the stability of supporting.

The front and rear frames of the foldable electric bed of the utility model are connected by the connector and the axle pin, and the front and rear frames are respectively provided with supporting parts, so as to lift the distance between the bed boards and the bases, which is convenient for arranging the drive components. Above all, at the folded position, the front and rear frames are close to each other and support each other, which reduces the stress on the connector, prolongs the service life of the connector and accordingly reduce the requirement on the strength of the connector. Therefore, the foldable electric bed of the utility model adopts the connector which has simple structure and is convenient for mounting, as shown by the utility model.

The above embodiments are only used as examples, without limiting the scope of the utility model. A person skilled in the art may envisage other implementations which can realize the same function, within the protection scope of the claims of the utility model, on this basis.

A person skilled in the art masters various embodiments, various variants and improvements. In particular, it should be cleared that the above features, variants and/or specific embodiments of the present utility model may be combined with each other, except the case of apparent contradiction or incompatibility. All these embodiments, variants and improvements belong to the protection scope of the utility model.

What is claimed is:

1. A foldable electric bed (1), comprising a front frame (3), a rear frame (5) and several pieces of bed boards arranged at the front frame (3) and the rear frame (5), characterized in that:
the front frame (3) is provided with a front base (31) which is fixedly provided with a front supporting part (32) used for supporting the bed boards arranged at the front frame (3), the rear frame (5) is provided with a rear base (51) which is fixedly provided with a rear supporting part (52) used for supporting the bed boards arranged at the rear frame (5), and wherein, the front base (31) and the rear base (51) are articulated at an articulating shaft (10) through a connector (7) and an axle pin (9), such that the front frame (3) and the rear frame (5) are able to fold in relation to each other between an unfolded position and a folded position;
at the unfolded position, the front frame (3) and the rear frame (5) are adjacent to each other along the horizontal direction; at the folded position, the front base (31) of the front frame (3) turns over to fit the rear base (51) of the rear frame (5) closely in the same horizontal plane around the articulating shaft (10).

2. The foldable electric bed (1) according to claim 1, characterized in that the connector (7) comprises a flat first mounting part (71) and a second mounting part (72) perpendicular to the first mounting part (71), said first mounting part (71) is adapted to mounting in the front frame (3) or the rear frame (5), and said second mounting part (72) is adapted to mounting in the axle pin (9).

3. The foldable electric bed (1) according to claim 1, characterized in that the front frame (3) is integrated with a front drive component (2) used for driving at least one of the several pieces of bed boards arranged at the front frame (3), and wherein the height of the front supporting part (32) protruding from the front base (31) is larger than the height of the front drive component (2) in the front frame (3).

4. The foldable electric bed (1) according to claim 1, characterized in that the rear frame (5) is integrated with a rear drive component (4) used for driving at least one of the several pieces of bed boards arranged at the rear frame (5), and wherein the height of the rear supporting part (52) protruding from the rear base (51) is larger than the height of the rear drive component (4) in the rear frame (5).

5. The foldable electric bed (1) according to claim 1, characterized in that the front base (31) of the front frame (3) comprises a pair of front longitudinal girders (33) extending along the length of said front frame, and a front connecting girder (34) and a front overturning girder (35) which are connected between the pair of front longitudinal girders (33), and the front overturning girder (35) is used for mounting the connector (7), wherein the front supporting part (32) is fixed at the pair of front longitudinal girders (33).

6. The foldable electric bed (1) according to claim 1, characterized in that the rear base (51) of the rear frame (5) comprises a pair of rear longitudinal girders (53) extending along the length of said rear frame, and a rear connecting girder (54) and a rear overturning girder (55) which are connected between the pair of rear longitudinal girders (53), and the rear overturning girder (55) is used for mounting the connector (7), wherein the rear supporting part (52) is fixed at the pair of rear longitudinal girders (53).

7. The foldable electric bed (1) according to claim 5, characterized in that the front connecting girder (34) of the front frame (3) is provided with front supporting feet (38) with the height equal to that of the front supporting part (32).

8. The foldable electric bed (1) according to claim 6, characterized in that the rear connecting girder (54) of the rear frame (5) is provided with rear supporting feet (58) with the height equal to that of the rear supporting part (52).

9. The foldable electric bed (1) according to claim 6, characterized in that the rear longitudinal girders (53) of the rear frame (5) are provided with rear longitudinal girder supporting feet (59) with the height equal to that of the rear supporting part (52).

10. The foldable electric bed (1) according to claim 1, characterized in that the front supporting part (32) at least partially supports two adjacent bed boards arranged at the front frame (3), and the rear supporting part (52) at least partially supports two adjacent bed boards arranged at the rear frame (3).
